(19) United States
(12) Patent Application Publication
(10) Pub. No.: US 2024/0077254 A1
(43) Pub. Date: Mar. 7, 2024

(54) Apparatus for Drying Gypsum Boards

(71) Applicant: Saint-Gobain Placo, Courbevoie (FR)

(72) Inventors: Peter Sutton, East Leake (GB); Binh Tran, Courevoie (FR); Sam McGaffin, Coventry (GB); Siva Kancharlapalli, Coventry (GB); Manish Patel, Chennai (IN); Amelie Tissot, Courbevoie (FR)

(21) Appl. No.: 18/262,244

(22) PCT Filed: Jan. 13, 2022
(86) PCT No.: PCT/EP2022/050686

§ 371 Date: Jul. 20, 2023

(30) Foreign Application Priority Data
Jan. 20, 2021 (EP) 21205069.3

(51) Int. Cl. F26B 23/04; F26B 3/06; F26B 3/28; F26B 21/08; F26B 21/10

(52) U.S. Cl. CPC F26B 23/04; F26B 3/06; F26B 3/28; F26B 21/08; F26B 21/10

(57) ABSTRACT

The present application describes an industrial drying apparatus for drying board precursor to form gypsum board, wherein the industrial drying apparatus comprises at least one electric heater. Use of the industrial drying apparatus and a method of drying a precursor board to form a gypsum board using the industrial drying apparatus are also described.

### FIELD OF THE INVENTION

The present invention relates to an industrial drying apparatus for drying a board precursor to form a gypsum board. More specifically, the invention relates to an industrial drying apparatus comprising an electric heater. The invention also relates to the use of the industrial drying apparatus and a method of drying board precursor to form gypsum board with the industrial drying apparatus.

### BACKGROUND TO THE INVENTION

Gypsum construction panels, often referred to as plasterboards, are commonly used in the provision of internal walls and ceilings within buildings. Whilst the major component of these construction panels is gypsum, also known as calcium sulphate dihydrate CaSO₄ 2(H₂O), it is well known to include additives such as fibres, starches and synthetic polymers amongst others to modify the chemical and mechanical properties of the gypsum board.

Typically, gypsum board is formed from a stucco slurry. Here, stucco (calcium sulphate hemihydrate, CaSO₄ 0.5(H₂O)) and other additives are combined with water to form the stucco slurry. The water within the slurry hydrates the stucco to form gypsum, and the gypsum slurry is dried at an elevated temperature to form the gypsum board. The gypsum board may have one or more facings, such as a paper sheet, although facings are not always used or desired.

Currently, the industrial production of gypsum boards relies on burners, most usually gas burners, and combustion processes to dry the board precursor to form the gypsum board. Here, hot air and combustion products from a combustion process within a burner move or are pushed through a drying apparatus to remove excess water and moisture from the board precursor to form the gypsum board.

It is desirable to closely control the drying process, as variations in the drying process and drying conditions can lead to significant changes in the properties of the gypsum board. Additionally, the drying process is relatively energy intensive, and it is desirable to reduce the energy required to form the gypsum board. With this aim in mind, work has been undertaken to reduce the water content of the board precursor as it enters the drying apparatus, for example by including fluidisers in the stucco slurry and a concomitant decrease in the slurry's water content.

However, there is a desire to further increase the controllability of the drying process, and to further reduce the energy required to dry the board precursor. Objects and aspects of the present invention seek to address at least one of these problems.

### SUMMARY OF THE INVENTION

According to the first aspect of the present invention, there is provided an industrial drying apparatus for drying board precursor to form gypsum board, wherein the industrial drying apparatus comprises at least one electric heater.

In this way, there is provided an apparatus that can more closely control the drying of a board precursor to form a gypsum board. Where the board precursor is dried with traditional combustion methods using a burner, it is challenging to control both the temperature experienced by the board precursor within the dryer and the rate of drying of the board precursor. The combustion temperature within the burner can vary depending on the precise combustion mixture within the burner, and the temperature may drift from a desired value over time, due to the chaotic nature of combustion.

Additionally, in traditional burner based systems the burner is located away from the board precursor. As such, it is necessary for the gases leaving the burner to travel to the dryer itself, often through vents or ducting, creating additional variability. It is also the case that at system start up, these vents or ducts must themselves be heated, reducing the heat that reaches the dryer to dry the board precursor. Therefore, using a burner based dryer, the drying of the board precursor during start up cannot be adequately controlled, often resulting in unusable gypsum board. An electric heater may also be more responsive than a gas burner. Advantageously, the need to purge the vents and ducts is also removed when replacing a gas burner with an electric heater. An electric heater can be positioned far closer to the board precursor and can reach a desired temperature more rapidly, reducing the variability of the drying process and thus increasing the uniformity of the gypsum board.

The use of an electric heater also increases the energy efficiency of the drying process. As mentioned above, the use of a burner in the drying process requires that the ducts and vents that transport the hot gases leaving the burner to the dryer must themselves be heated. Such ducts and/or vents are not essential when using an electric heater in the dryer and, therefore, no energy is lost heating them or maintaining their temperature. Additionally, to maintain combustion within the burner it is necessary to continuously supply fresh air and fuel to the burner. Therefore, a significant amount of energy in these burner based systems is wasted heating this fresh air and the combustion fuel, rather than drying the board precursor. The fresh air requirement is greatly reduced, and potentially even eliminated, in systems using an electric heater, resulting in increased efficiency.

An industrial drying apparatus is one that is capable of dying sufficient board precursor to form 500 m² or more of gypsum board per hour. The production of gypsum board on this scale is only seen in specialist manufacturing plants, and such large scale processing has different technical characteristics to any lab-based research based processes, or small batch production processes. Preferably, the industrial drying apparatus is configured such that it may continuously dry board precursor to form gypsum board. In this way, the industrial drying apparatus is a continuous dryer.

Preferably, the industrial drying apparatus comprises a heating control system for controlling the output of the at least one electric heater. More preferably, the heating control system will comprise a computer processor configured to control the at least one electric heater to maintain a heating parameter within a desired range. The heating parameter may comprise the electric current supplied to the electric heater, the electrical resistance of an element within the electric heater, the time period for which electrical power is supplied to the electric heater and/or the time period for which electrical power is not supplied to the electric heater, amongst others. The heating parameter may comprise the rate at which air flows through at least one electric heater. More preferably, the heating parameter may comprise solely the rate at which air flows through at least one electric heater. The flow rate of air may be a mass flow rate or a volumetric flow rate.

Preferably, the desired range may be predetermined. Alternatively, the desired range may be selected by a user. More preferably, the desired range may change over time. Still more preferably, the change over time is cyclical. It is envisaged that the desired range may comprise a range of values, or be a single value. Preferably, the heating control system is configured to issue an alert if the heating parameter falls outside the desired range. More preferably, the heating control system is configured to issue an alert if the heating parameter falls outside the desired range for more than a specified length of time. This specified length of time may be predetermined or selected by the user. Preferably, the alert comprises an audible alert. Preferably, the alert comprises a visual alert. Preferably, the issuance of an alert is recorded within the heating control system.

Preferably, the heating control system comprises at least one temperature sensor located within the industrial drying apparatus. More preferably, the heating control system comprises a plurality of temperature sensors located within the industrial drying apparatus. More preferably, temperature sensors within the plurality of temperature sensors are located at separate, distinct locations with the industrial drying apparatus. Preferably, the heating control system is configured to control the at least one electrical heater in response to the measurement of at least one temperature sensor. For example, the control system may modify the operation of at least one electric heater if the temperature measured by one or more temperature sensors falls outside of a desired range as hereinbefore described. Preferably, the temperature sensor is configured to measure the temperature of the board precursor as it exits the industrial drying apparatus.

Preferably, the industrial drying apparatus comprises at least one humidity modifier. Preferably, the humidity modifier can increase the humidity within the industrial drying apparatus. Preferably, the humidity modifier can reduce the humidity within the industrial drying apparatus. More preferably, the humidity modifier can increase or reduce the humidity within the industrial drying apparatus.

It is advantageous to control the humidity within the industrial drying apparatus, as, whilst it is the aim of the drying apparatus to remove moisture from the board precursor to form a gypsum board, controlling the humidity inside the industrial drying apparatus allows the speed of the drying process to be adjusted to vary the properties of the gypsum board.

Preferably, the industrial drying apparatus comprises a humidity control system for controlling the output of the at least one humidity modifier. More preferably, the humidity control system comprises a computer processor configured to control the humidity modifier to maintain a humidity parameter within a desired range. The humidity parameter may comprise the rate of steam and/or water vapour introduction into the industrial drying apparatus, the rate of steam and/or water vapour removal from the industrial drying apparatus, the time period for which steam and/or water vapour is introduced into the electric drying apparatus and/or the time period for which steam and or water vapour is removed from into the electric drying apparatus, amongst others.

Preferably, the desired range may be predetermined. Alternatively, the desired range may be selected by a user. More preferably, the desired range may change over time. Still more preferably, the change over time is cyclical. It is envisaged that the desired range may comprise a range of values, or be a single value. Preferably, the humidity control system is configured to issue an alert if the humidity parameter falls outside the desired range. More preferably, the heating control system is configured to issue an alert if the humidity parameter falls outside the desired range for more than a specified length of time. This specified length of time may be predetermined or selected by the user. Preferably, the alert comprises an audible alert. Preferably, the alert comprises a visual alert. Preferably, the issuance of an alert is recorded within the humidity control system.

Preferably, the humidity control system comprises at least one humidity sensor located within the industrial drying apparatus. More preferably, the humidity control system comprises a plurality of humidity sensors located within the industrial drying apparatus. More preferably, humidity sensors within the plurality of humidity sensors are located at separate, distinct locations with the industrial drying apparatus. Preferably, the humidity control system is configured to control the at least one humidity modifier in response to the measurement of at least one humidity sensor. For example, the control system may modify the water vapour and/or steam output of at least one humidity modifier if the humidity measured by one or more humidity sensors falls outside of a desired range as hereinbefore described. Preferably, the humidity sensor is configured to measure the moisture content of the board precursor as it exits the industrial drying apparatus. More preferably, the humidity sensor is configured to measure the moisture content of the board precursor across its width. In this way, a profile of the moisture content of the board precursor may be obtained or calculated, and drying conditions modified in view of this profile.

Preferably, the humidity control system comprises an actuated damper connected to a source of fresh air. In this case, a measurement taken by at least one humidity sensor will cause the damper to be actuated to increase and/or restrict the flow of fresh air from the fresh air source. In this way, the humidity within the industrial drying apparatus can be controlled as desired

Where the industrial drying apparatus comprises a plurality of temperature and/or humidity sensors, this may advantageously allow the temperature and/or humidity of the electric drying apparatus to be more finely controlled with the industrial drying apparatus. Additionally, where a plurality of sensors are used, it may be advantageous to provide different temperatures and/or a different humidity in different areas or zones of the industrial drying apparatus to control more closely the final properties of the gypsum board.

Preferably, the industrial drying apparatus comprises a body portion configured to, in use, allow the continuous passage of board precursor. More preferably, the drying apparatus comprises at least one member that, in use, is powered to progress the board precursor through the body portion. More preferably, the at least one member comprises at least one roller. More preferably, the body portion is elongate with a central void, aperture or passageway. Preferably, the industrial drying apparatus is configured to, in use, dry a plurality of board precursors simultaneously.

Preferably, the at least one electric heater is arranged to, in use, dry the board precursor via radiative heat transfer. The use of radiative heat transfer to dry the board may be advantageous as it is more efficient than other methods of heat transfer. More preferably, the at least one electric heater is arranged to, in use, dry the board precursor via radiative and conductive heat transfer.

Preferably, the at least one electric heater is arranged to, in use, dry the board precursor via convective heat transfer. More preferably, in use, the at least one electric heater is located substantially below or above, or separately to the board precursor. Still more preferably, in use, the at least one electric heater is located substantially below or above, or separately to a plurality of board precursors.

Preferably, the industrial drying apparatus comprises a plurality of electric heaters.

Where the industrial drying apparatus comprises a plurality of electric heaters, the industrial drying apparatus may be more responsive as it may be possible to create a tuned drying profile. Where an industrial drying apparatus uses a gas burner, that gas burner defines the drying profile across a large volume. Therefore, when a change in the temperature is needed in one or more areas, the operation of the gas burner must be changed for the whole volume of industrial drying apparatus. On the other hand, with a plurality of electric heaters, the industrial drying apparatus can offer fine control of the drying profile such that the drying profile can be modified over a small volume or in an individual zone.

Where the apparatus comprises a plurality of electric heaters, the industrial drying apparatus may preferably be configured such that, in use, each of the electric heaters is located on one side of the board precursor. Alternatively, the industrial drying apparatus is configured such that, in use, the electric heaters are located on both sides of the board precursor. Preferably, the industrial drying apparatus comprises at least one pair of electric heaters positioned substantially opposite one another. More preferably, all of the electric heaters within the plurality of electric heaters are positioned in opposing pairs. The side may be the top surface, bottom surface or a lateral surface of a board precursor.

Preferably, each electric heater within the plurality of electric heaters is configured to be independently controlled. Preferably, the independent control comprises controlling the heat output of each electric heater independently. Preferably, at least one electric heater comprises sections, with each section being configured to be independently controlled. Controlling individual heaters, or sections of a single heater independently, may be advantageous as it may allow finer control of the drying process, and may allow different areas of the board precursor to be dried at different rates.

Preferably, the drying apparatus comprises electric heaters located at a plurality of discrete positions within the industrial drying apparatus. Again, such a feature may be advantageous as it may allow the board precursor to be dried at different rates, or under different conditions, in different areas or zones of the industrial drying apparatus.

Preferably, the industrial drying apparatus comprises an air recovery unit. The presence of an air recovery unit may be advantageous as it may allow the air heated by the electric heaters in the drying process to be recovered and re-used. In this way, the efficiency of the drying process is increased. More preferably, the air recovery unit comprises a supplementary electric heater. The presence of a supplementary electric heater in the air recovery unit allows the temperature of the recovered air to be increased, improving its potential for re-use within the industrial drying apparatus. Such a recovery process is not feasible with traditional burner based systems due to the remote location of the burner, combustion safety requirements and the complexity of the system purge sequence. Heating the recovered air with a supplementary electric heater can improve evaporative capacity, avoid unwanted condensation within the industrial drying apparatus, prevent a quality issue with the gypsum board and/or provide a fail-safe in case of an interruption in the source of recovered air, or interruption of downstream apparatus.

Preferably, the industrial drying apparatus comprises at least one fan in fluid communication with the at least one electric heater. More preferably, the industrial drying apparatus comprises a plurality of fans in fluid communication with the at least one electric heater. Still more preferably, the industrial drying apparatus comprises a plurality of electric heaters and a plurality of fans, each fan within said plurality of fans in fluid communication with one electric heater within the plurality of electric heaters.

Preferably, the at least one fan is located upstream of the at least one electric heater. Alternatively, the at least one fan is located downstream of the at least one electric heater. More preferably, where the industrial drying apparatus comprises a plurality of fans and a plurality of electric heaters, at least one fan is located upstream of an electric heater within the plurality of electric heaters and at least one fan is located downstream of an electric heater within the plurality of electric heaters. Where the electric heater is being retrofitted to an existing industrial drying apparatus, it may be advantageous to locate the electric heater upstream of the fan to ease the installation process.

According to a second aspect of the present invention, there is provided the use of the industrial drying apparatus as hereinbefore described to dry a board precursor to form gypsum board.

According to a third aspect of the present invention, there is provided a method of drying board precursor to form gypsum board, the method comprising the steps of: providing the industrial drying apparatus as hereinbefore described, providing board precursor, placing the board precursor into the industrial drying apparatus, exposing the board precursor to heat from the at least one electric heater, and drying the board precursor to form gypsum board.

Preferably, the step of placing the board precursor into the industrial drying apparatus comprises continuously passing the board precursor through the industrial drying apparatus. Such a feature may be advantageous as it may provide a continuous drying process.

It is to be understood that each and/or any feature and/or advantage associated with the first aspect of the present invention may also be included and/or apply to each and/or both of the second and third aspects of the present invention.

### DETAILED DESCRIPTION

Embodiments of the present invention will now be described by way of example only and with reference to the accompanying drawings, in which:

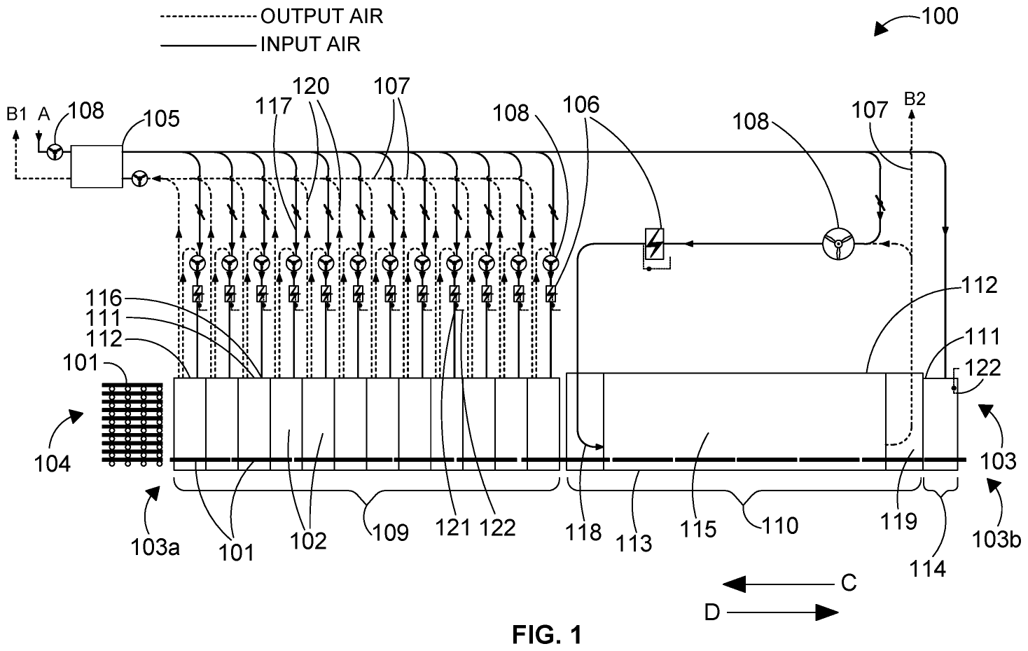

FIG. 1 is a diagram of an industrial drying apparatus in accordance with the first aspect of the invention; and

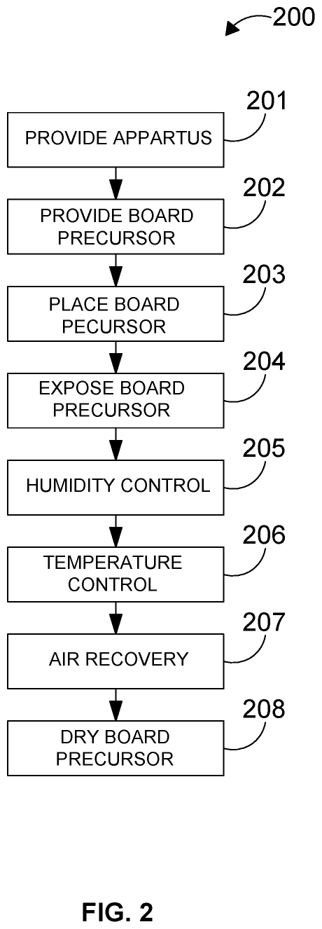

FIG. 2 is a schematic view of a method of drying board precursor to form gypsum board according to the third aspect of the present invention.

With reference to FIG. 1, there is illustrated an industrial drying apparatus 100 for drying board precursor 101 to form gypsum board.

The industrial drying apparatus 100 comprises a body portion 103 configured to, in use, allow the continuous passage of board precursor 101. The body portion 103 comprises a first end 103a and a second end 103b and the body portion 103 is elongate with a central passageway extending from the first end 103a to the second end 103b. The industrial drying apparatus 100 comprises a member comprising a plurality of rollers that, in use, are powered to progress the board precursor 101 through the body portion 103. The board precursor 101 enters the industrial drying apparatus 100 at the first end 103a and the board precursor 101 is allowed continuous passage from the first end 103a until it exits the industrial drying apparatus 100 at the second end 103b.

The body portion 103 is divided into a plurality of distinct drying chambers or zones 102 arranged in sequence, starting in a primary region 109 at the first end 103a followed by a secondary region 110 and finishing in a tertiary region 114 at the second end 103b. The drying zones 102 are adjacent such that the board precursor 102 passes through each drying zone 102 in turn.

The primary region 109 comprises a plurality of drying zones 102 of substantially equal dimensions. In this embodiment, the primary region 109 uses crossflow, airflow perpendicular to the longitudinal axis of the board precursors 101, to dry the board precursors 101. The secondary region 110 comprises a first exterior drying zone 118 and a second exterior drying zone 119 separated by an elongate drying zone 115. In this embodiment, the secondary region uses longitudinal flow airflow parallel to the longitudinal axis of the board precursors 101, to dry the board precursors 101. In this embodiment, the tertiary region 114 comprises a single drying zone 102. It is envisaged by the applicant that the industrial drying apparatus 100 may use only longitudinal flow, only crossflow, or a combination of longitudinal flow and crossflow to dry the board precursors 101.

The industrial drying apparatus 100 further comprises a plurality of decks 104 for supporting a plurality of board precursor 101. The plurality of desks 104 are progressed through the drying apparatus 100 by the plurality of rollers such that all decks of the plurality of decks 104 pass through each drying zone of the plurality of drying zones 102 simultaneously. In this way, the industrial drying apparatus 100 is configured to dry a plurality of board precursors 101 simultaneously.

The industrial drying apparatus 100 comprises an air inlet A and, in use, air enters the drying apparatus 100 via the air inlet A. Each drying zone of the plurality of drying zones 102 is arranged in fluid communication with the air inlet A. The air entering the industrial drying apparatus 100 via the air inlet A is divided within the apparatus 100 such that the apparatus 100 comprises a plurality of discrete air inputs 107. As such, in use, there is a discrete air input 107 to each drying zone of the plurality of drying zones 102. Each discrete air input 107 comprises a valve 120 for controlling the flow rate of input air entering each drying zone 102. In this way, each discrete air input 107 can be independently controlled.

The industrial apparatus 100 further comprises a plurality of electric heaters 106 located at a plurality of discrete positions within the industrial drying apparatus 100. The plurality of electric heaters 106 are located proximate, in this case adjacent to, the plurality of drying zones 102. In use, each discrete air input 107 passes via an electric heater 106 before entering the respective drying zone 102. The electric heater 106 is configured to heat the air entering the drying zone 102 for drying of the board precursor 101. The heated air transfers thermal energy to the board precursor 101 such that the plurality of electric heaters are arranged to, in use, dry the board precursor 101.

The heated air enters each drying zone 102 at a top surface 112 with a speed such that the heated air travels towards a bottom surface 113 of each drying zone 102. In the first region 109, the heated air flows over the board precursor in substantially direction C within each drying zone 102. Namely, the heated air enters each drying zone 102 towards the side of the drying zone 102 proximate the second end 103b and the heated air flows along the board precursor 101 to the side of the drying zone 102 proximate the first end 103a. An exhaust air outlet 111 is located near the side of each drying zone 102 proximate the first end 103a, and each exhaust air outlet 111 is in fluid connection with a first air outlet B1. In the secondary region 110, the heated air enters the first exterior drying zone 118. An exhaust air outlet 111 is located at the downstream end of the secondary region 110, namely, at the second exterior drying zone 119 located proximate the second end 103b. The exhaust air outlet 111 of the secondary region 110 is in fluid connection with a second air outlet B2. Heated air flows over the board precursor and through the elongate drying zone 115 in substantially direction D. The drying zone 102 of the tertiary region 114 is in fluid communication with a single discrete air input 107.

The member comprising a plurality of rollers and the plurality of decks 104 are configured such that when the board precursor 101 is progressing through the body portion 103 heated air passes on both sides of the board precursor 101.

The industrial drying apparatus 100 further comprises a heating control system for controlling the output of the plurality of electric heaters 106 and each electric heater of the plurality of electric heaters 106 is configured to be independently controlled, such that the heat output of each electric heater 106 is independently controlled. In this way, each drying zone of the plurality of drying zones 102 can be heated to a temperature independent of the other drying zones 102.

The heating control system comprises a computer processor configured to control the plurality of electric heaters 106 to maintain a heating parameter within a desired range. The desired range changes cyclically over time, such that the plurality electric heaters 106 each maintain the desired output throughout the industrial drying process. The heating control system is configured to issue an alert if the heating parameter falls outside the desired range for more than a specified length of time. In this way, the user can monitor the operation of the industrial drying apparatus 100 and act when undesirable drying conditions are provided. The issuance of each alert is recorded within the heating control system such that historical function of the industrial drying apparatus 100 can be monitored.

The heating control system further comprises a plurality of temperature sensors 121 located within the industrial drying apparatus 100. Temperature sensors within the plurality of temperature sensors 121 are located at separate, distinct locations with the industrial drying apparatus 100. In this embodiment, a temperature sensor 121 is located proximate each electric heater 106, or within each drying zone, to measure the temperature of the air heated by each electric heater 106. The heating control system is configured to control each electric heater 106 in response to the measurement of the corresponding temperature sensor 121. In this way, the temperature of air for drying the board precursor 101 is measured such that the drying conditions can be monitored and adjusted if required.

The industrial drying apparatus 100 further comprises a plurality of humidity modifiers and a humidity control system for controlling the output of the plurality of humidity modifiers. Each humidity modifier of the plurality of humidity modifiers can both increase or reduce the humidity within the industrial drying apparatus 100. The humidity control system comprises a computer processor configured to control each humidity modifier to maintain a humidity parameter within a desired range. The desired range changes cyclically over time, such that the plurality humidity modifiers each maintain the desired output throughout the industrial drying process. The humidity control system is configured to issue an alert if the humidity parameter falls outside the desired range for more than a specified length of time. In this way, the user can monitor the operation of the industrial drying apparatus 100 and act when undesirable drying conditions are provided. The issuance of each alert is recorded within the humidity control system such that historical function of the industrial drying apparatus 100 can be monitored.

The humidity control system comprises a plurality of humidity sensors 122 located at separate, distinct locations within the industrial drying apparatus 100. In this embodiment, a humidity sensor 122 is located proximate each drying zone 102 to measure the humidity conditions within the drying zone 102. In this embodiment, the humidity sensors 122 are located adjacent the temperature sensors 121. The humidity control system is configured to control each humidity modifier in response to the measurement of the plurality of humidity sensors 122. Further, a humidity sensor 122 is located proximate the tertiary region 114. In this way, the humidity sensor 122 in the tertiary region 114 is configured to measure the moisture content of the board precursor 101 as it exits the industrial drying apparatus 100.

As the industrial drying apparatus 100 comprises a plurality of temperature 121 and humidity 122 sensors, this advantageously allows the temperature and humidity within the drying apparatus 100 to be more finely controlled. Additionally, as a plurality of sensors are used, different temperatures and/or a different humidity can be provided within each drying zone 102 to control more closely the final properties of the gypsum board. For example, the temperature and/or humidity profile delivered by the plurality of electric heaters 106 can be modified to account for differences in board precursor 101 thickness, width and edge profile; the number of decks in the plurality of decks; and any known inconsistences in air flow within the plurality of drying zones 102.

The industrial drying apparatus 100 further comprises an air recovery unit that allows the hot air from the drying chambers and drying zones 102 to be recovered and re-used. The air recovery unit comprises a primary recovery system and a secondary recovery system. FIG. 1 illustrates the input air entering the plurality of drying zones 102 and the output air exiting the plurality of drying zones 102.

The primary recovery system comprises a plurality of recirculation loops 117 and each recirculation loop 117 comprises a recirculation outlet 116. In the first region 109, each drying zone 102 comprises a recirculation loop 117 and exhaust air to be recirculated exits each drying zone 102 via the recirculation outlet 116. In use, the recirculated air is combined, within each recirculation loop 117, with the input air from each discrete air input 107. The combined air is then heated by an electric heater 106 for use in drying the board precursor 101. In this way, the recirculated air, and any thermal energy it posses, are re-used in the industrial drying process. The primary recovery system of the secondary region 110 comprises a single recovery loop with a recirculation outlet 116 located at the downstream end of the secondary region 110 in the second exterior drying zone 119.

The secondary recovery system comprises a plurality of exhaust air outlets 111 arranged in fluid communication with the external environment of the industrial drying apparatus 100. The secondary recovery system extracts heat from the exhaust air of each drying zone before the exhaust air exits the industrial drying apparatus and enters the external environment. In the primary region 109, each drying zone 102 comprises an exhaust air outlet 111 and, in use, exhaust air from each drying zone 102 exits each drying zone 102 via each exhaust air outlet 111. The exhaust air is then combined such that all exhaust air from the first region 109 exits the drying apparatus 100 via the first air outlet B1. The secondary region 110 comprises a single exhaust air outlet 111 in fluid communication with the external environment of the industrial drying apparatus via a second air outlet B2. The exhaust air outlet 111 of the secondary region 110 is located in the second exterior drying zone 119 proximate and, in this embodiment, is equivalent to the recirculation outlet 116.

The secondary recovery system further comprises a heat exchanger 105. The heat exchanger 105 extracts thermal energy from the exhaust air of the first region 109 before the exhaust air exits the industrial drying apparatus 100 via the first outlet B1. In this way, thermal energy is recovered from the exhaust air and there is a reduced demand on the plurality of electric heaters 106 to heat the input air to the desired temperature.

The industrial drying apparatus 100 further comprises a plurality of fans 108 for assisting in the recirculation of the recirculated exhaust air and in the combining of input air and recirculated exhaust air. A fan 108 is located proximate each electric heater 106 such that each electric heater 106 is located between a fan 108 and a drying zone 102. In this way, the input air and recirculated exhaust air can be combined and accelerated to a homogenous, desired speed prior to heating and drying of the board precursor 101. A fan of the plurality of fans 108 is located between the air inlet A and the heat exchanger 105 to assist in progressing inlet air through the heat exchanger 105. Additionally, a fan of the plurality of fans 108 is located adjacent the heat exchanger 105 to assist in progressing exhaust air form the plurality of recirculation loops 117 through the heat exchanger 105.

Whilst in the present embodiment the fans 108 are located upstream of the electric heaters 106, it is also envisaged that the fans 108 may be downstream of the heaters 106 such that the fans 108 are located between the electric heaters 106 and the drying zones 102. Embodiments of the invention where fans 108 are located both upstream and downstream of the heaters 106 are also envisaged.

With reference to FIG. 2, there is illustrated a method 200 of drying board precursor to form gypsum board.

The method 200 comprises a PROVIDE APPARATUS step 201 wherein an industrial apparatus in accordance with the first aspect of the present invention is provided. There follows a PROVIDE BOARD PRECURSOR step 202, wherein board precursor is provided. The board precursor is then placed into the industrial drying apparatus in a PLACE BOARD PRECURSOR step 203. The PLACE BOARD PRECURSOR step 203 comprises continuously passing the board precursor through the industrial drying apparatus. In the embodiment of FIG. 1, the board precursor 101 is placed onto a deck of the plurality of decks 104 for progression through the body portion 103 of the industrial drying apparatus 100.

There follows an EXPORSE BOARD PRECURSOR step 204, wherein the board precursor is exposed to heat from at least one electric heater. The humidity within the industrial drying apparatus is controlled and modified in a HUMIDITY CONTROL step 205. Wherein the provided apparatus is the apparatus 100 of FIG. 1, the plurality of humidity modifiers and the humidity control system modify the humidity to maintain a humidity parameter within a desired range.

There follows a TEMPERATURE CONTROL step 206, wherein the temperature within the industrial drying apparatus is controlled. Wherein the provided apparatus is the apparatus 100 of FIG. 1, the heating control system modifies the temperature with the output of the plurality of electric heaters 106 in response to the measurement of the corresponding temperature sensor 121.

There follows an AIR RECOVERY step 207 wherein thermal energy and air is recirculated and re-used in the industrial drying process. In the embodiment of FIG. 1, the primary recovery system recirculates air, and any thermal energy it posses, to be re-used, and the secondary recovery system extracts heat from the exhaust air of each drying zone before the exhaust air exits the industrial drying apparatus and enters the external environment.

The board precursor is then dried to form gypsum board in a DRY BOARD PRECURSOR step 208.

1. An industrial drying apparatus for drying board precursor to form gypsum board, wherein said industrial drying apparatus comprises at least one electric heater.

2. The industrial drying apparatus of claim 1, wherein said industrial drying apparatus comprises a heating control system configured to control an output of the at least one electric heater.

3. The industrial drying apparatus of claim 2, wherein said heating control system comprises at least one temperature sensor located within said industrial drying apparatus.

4. The industrial drying apparatus of claim 1, wherein said industrial drying apparatus further comprises at least one humidity modifier.

5. The industrial drying apparatus of claim 4, wherein said industrial drying apparatus comprises a humidity control system for controlling the output of the at least one humidity modifier.

6. The industrial drying apparatus of claim 5, wherein said humidity control system comprises at least one humidity sensor located within said industrial drying apparatus.

7. The industrial drying apparatus of claim 1, wherein the at least one electric heater is arranged to, in use, dry the board precursor via radiative heat transfer.

8. The industrial drying apparatus of claim 1, wherein the at least one electric heater is arranged to, in use, dry the board precursor via convective heat transfer.

9. The industrial drying apparatus of claim 1, wherein said industrial drying apparatus comprises a plurality of electric heaters.

10. The industrial drying apparatus of claim 9, wherein each electric heater within said plurality of electric heaters is configured to be independently controlled.

11. The industrial drying apparatus of claim 9, wherein electric heaters are located at a plurality of discrete positions within said industrial drying apparatus.

12. The industrial drying apparatus of claim 1, wherein said industrial drying apparatus comprises an air recovery unit.

13. The industrial drying apparatus of claim 12, wherein said air recovery unit comprises a supplementary electric heater.

14. (canceled)

15. A method of drying board precursor to form gypsum board, the method comprising the steps of:
providing the industrial drying apparatus of claim 1;
providing board precursor;
placing the board precursor into said drying apparatus;
exposing the board precursor to heat from the at least one electric heater; and
drying the board precursor to form gypsum board.
